(19) United States
(12) Patent Application Publication
(10) Pub. No.: US 2007/0157271 A1
(43) Pub. Date: Jul. 5, 2007

(54) Digital broadcasting receiving apparatus and operation control method

(75) Inventor: Michiaki Hiraoka, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/478,183

(22) Filed: Jun. 28, 2006

(30) Foreign Application Priority Data
Jun. 29, 2005 (JP) P.2005-190746

(51) Int. Cl. H04N 7/173; H04M 1/00; H04N 7/16

(52) U.S. Cl. 725/100; 455/550.1; 725/62; 725/131

(57) ABSTRACT

A portable terminal 1 comprises a judgment section 23 which judges whether or not digital broadcasting corresponding to an interactive service is received, and a control section 24 which enables an operation section 10 corresponding to the interactive service, in case that transmission of data corresponding to the interactive service is possible when it is judged by the judgment section 23 that the interactive service is received, and which disables the operation section 10, in case that transmission of data corresponding to the interactive service is impossible when it is judged by the judgment section 23 that the interactive service is received.

### TECHNICAL FIELD

The present disclosure relates to a digital broadcasting receiving apparatus and an operation control method, by which it is possible to utilize an interactive service.

### RELATED ART

An interactive service of digital broadcasting is a service in which a user can participate by operating a broadcasting receiving apparatus, which is receiving broadcasting waves, to transmit information through a communication line. In order to enter into such a service, a key operation has to be carried out correctly, in accordance with an instruction displayed on a screen of a program corresponding to an interactive service. Especially, in case of transmitting an answer of a quiz program, or in case of entering into a program such as auction, TV shipping etc. of hot items, a user has such a strong desire that the user must carry out a key operation at short times, and habituation is necessary in order to carry out a correct key operation at short times.

In the mean time, in case of carrying out an interactive service by the use of a fixed mount type (stationary type) digital broadcasting receiving apparatus, an operation method by use of color buttons (4 colors) as an operation section is commonly used. In addition, as one example of this broadcasting receiving apparatus, there is a portable telephone on which a digital broadcasting receiving function is mounted. However, in case of a portable telephone, a lot of operation keys have been already mounted, in association with realization of high performance. Therefore, over fear of such a matter that an operation method becomes complex by adding any further operation keys, it is also considered to respond to it by allocating functions of color buttons to existing operation keys, without newly adding a color button.

Meanwhile, Japanese Patent Unexamined Publication No. 2001-217904 discloses a technology which enables realization of multiple functions, by utilizing an operation key section, without interfering with miniaturization of a telephone main body and expansion of an area of a display section.

However, transmission of information to an interactive service is carried out by use of a communication line. Therefore, the information cannot be always transmitted by use of a communication line even if digital broadcasting can be received. Especially, in case that a communication line is of wireless, it varies from hour to hours, depending on a position and an environment where the broadcasting receiving apparatus is utilized.

Therefore, not only in case of carrying out an operation by use of a color button, but also in case of carrying out an operation by use of an operation key (button) which is allocated for use in watching digital broadcasting (TV application), there occurs such a problem that a user has to check display for a communication line and check a status of the communication line, in case of transmitting information to an interactive service by use of the communication line.

In addition, especially, in case of a portable telephone on which a digital broadcasting receiving function is mounted, there is a case that the user uses full-screen display to watch the digital broadcasting because of the small screen size. In that case, display for a communication line is omitted, and it is not possible to check a status of the communication line.

In addition, in order to avoid it, if display for a communication line is carried out on a part of a display screen, a data (program) display area of broadcasting waves becomes small, and there occurs such a problem that it becomes difficult for a user to watch a program by the small data display area. Even if viewing difficulty is not concerned, in case that a user concentrates on TV watching, there is also such a problem that the user is not aware of display information for a communication line, which is displayed at an end portion of a display screen.

In addition, in case of carrying out an operation by use of an operation key (button) which is allocated for watching digital broadcasting (TV application), it becomes complex to know which function is allocated to which operation key, and there occurs such a problem that a user transmits information by mistake, and transmits it redundantly.

### SUMMARY

Embodiments of the present invention provide a digital broadcasting receiving apparatus, by which it is possible to utilize an interactive service, which can improve user's usability and prevent a user's erroneous operation.

According to an aspect of one or more embodiments of the invention, a digital broadcasting receiving apparatus comprises a judgment section which judges whether or not digital broadcasting corresponding to an interactive service is received, and a control section which enables an operation section corresponding to the interactive service when it is judged by the judgment section that the digital broadcasting is received and transmission of data corresponding to the interactive service is possible, and which disables the operation section when it is judged by the judgment section that the digital broadcasting is received and transmission of data corresponding to the interactive service is impossible.

In the present invention, preferably, it comprises a light emitting section which illuminates the operation section, and the control section notifies enable/disable of the operation section by light emission control of the light emitting section.

In the present invention, preferably, it comprises a wireless communication section for use in data communication, which can carry out data transmission for the interactive service, and a status judgment section which judges an electromagnetic wave status used by the wireless communication section, and the control section judges whether or not transmission of data corresponding to the interactive service is possible based on the electromagnetic wave status judged by the status judgment section.

In the present invention, preferably, the control section controls, when the operation section is operated in a state that the operation section is disabled, holding of information based on the operation and reserving of data transmission and transmitting of the held reserved and held information when data transmission becomes possible.

In the present invention, preferably, the control section cancels transmission reservation and deletes corresponding information, when the reserved data transmission is not carried out within a predetermined period of time.

In the present invention, preferably, the control section obtains the predetermined period of time, from data of the interactive service.

According to another aspect of one or more embodiments of the invention, an operation control method monitors whether or not digital broadcasting corresponding to an interactive service is received, and enables an operation section corresponding to the interactive service when the digital broadcasting is received and transmission of data corresponding to the interactive service is possible, and disables the operation section when the digital broadcasting is received and the transmission of data corresponding to the interactive service is impossible.

In the present invention, preferably, it is judged whether or not transmission of data corresponding to the interactive service is possible based on a status of wireless communication of a wireless communication business entity to a communication network.

In the present invention, preferably, enable/disable of the operation section is notified by light emission control of the operation section.

Various implementations may include one or more the following advantages. For example, in a digital broadcasting receiving apparatus by which it is possible to utilize an interactive service, a user is easy to use it, and does not carry out an erroneous operation.

### BRIEF DESCRIPTION OF THE DRAWINGS

FIG. 1 is a block diagram of a portable terminal according to an embodiment of the present invention.

FIG. 2 (A) and FIG. 2 (B) are external appearance views of the portable terminal in such a state that it is possible to view an operation key and a display section.

FIG. 3 (A) is a flow chart of basic light emission control of LED.

FIG. 3 (B) is a flow chart regarding description on a display screen.

FIG. 4 is a flow chart of another embodiment regarding description on the display screen.

FIG. 5 (A) and FIG. 5 (B) are views which show one example of a program screen utilizing an interactive service.

FIG. 6 (A) and FIG. 6 (B) are views which show an example of messages (descriptions) regarding processing and statuses.

FIG. 7 is a block diagram of a portable terminal which relates to a comparative example.

### DETAILED DESCRIPTION

The present invention is widely applicable to such a case that a broadcasting receiving function is added to a computer, a portable telephone, a game machine, a camera, a car navigation system or a motion picture reproducing apparatus, etc., especially to a portable type device which is freely movable.

Hereinafter, an embodiment of the present invention will be explained by using a portable telephone with a broadcasting receiving function (hereinafter, referred to as a portable terminal) as an example.

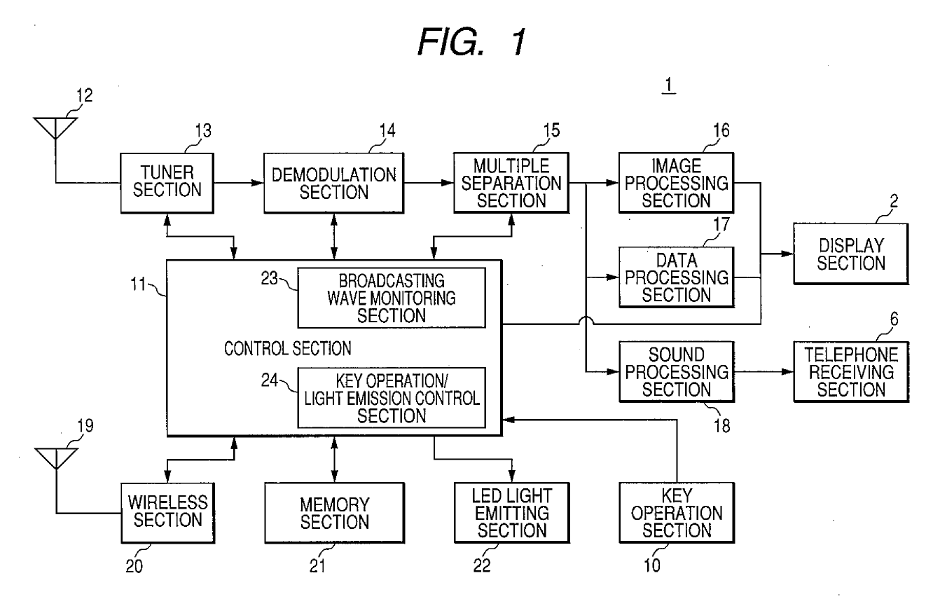

FIG. 1 shows a block diagram of such a portable terminal according to an embodiment of the present invention.

A portable terminal 1, which is shown graphically, has a function of receiving digital broadcasting.

As a basic configuration for realizing this function, the portable terminal 1 has a display section 2, a telephone receiving section 6, a key operation section 10, a broadcasting antenna section 12, a tuner section 13, a demodulation section 14, a multiple separation section 15, an image processing section 16, a data processing section 17 and a sound processing section 18. The display section 2 displays received program contents or image information and data of a channel selection and other setting screen etc. The telephone receiving section 6 outputs sound. The key operation section 110 carries out various inputs. The broadcasting antenna section 12 receives digital broadcasting waves. The multiple separation section 15 separates a data stream from the demodulation section 14.

The image processing section 16 is constituted by three processing sections and carries out processing to images, data and sound which are separated by the multiple separation section 15.

The above-mentioned each section is controlled by a control section 11, and carries out a predetermined function.

The broadcasting section 12 of the portable terminal 1 receives signals (OFDM modulating signals) which were overlapped with digital broadcasting waves transmitted from an electromagnetic wave tower (not shown in the figure) of a broadcasting station (or for use in relay) placed every receiving coverage. This digital broadcasting waves includes digital broadcasting signals of plural broadcasting stations every frequency band (channel) thereof. A channel selection screen is displayed on the display section 2, and when a user, who saw it, selects one channel from the key operation section 10, channel selection frequency of the tuner section 13 is tuned with frequency of a receiving signal of that selected channel, and the receiving signal of the channel is demodulated by the demodulation section 14, and it is converted into an encode string (data stream) by its A/D conversion function.

The data stream is, then, separated into broadcasting images (moving images), data and sound, in the multiple separation section 15, and the images are sent to the image processing section 16, and the data is sent to the data processing section 17, and the sound is sent to the sound processing section 18. Here, the “data” means, in case that received digital broadcasting corresponds to a service by interactive data (hereinafter, referred to as interactive service), that data. The “data” includes textual information in news flash, TV shipping etc., pictographic information of an operation panel etc. in an operation guide service, sound information such as emergency warning, a still image such as a logo mark of a broadcasting station, and so on. In addition, since it is interactive, in case of sending textual information etc. from the portable terminal 1 side to a broadcasting station, that textual information etc. are one kind of the above-mentioned “data”.

Images (still images and moving images), which are processed by the image processing section 16, the data processing section 17 and the sound processing section 18, are displayed on the display section 2, and sound is outputted from the telephone receiving section 6, a speaker which is not shown in the figure, and so on.

The portable terminal 1 has, as a configuration for realizing a talking function, a communication antenna section 19 for a wireless telephone line, a wireless section 20, and a memory section 21 which stores user data and communication channel information etc.

The wireless section 20 is a communication section for carrying out wireless communication to a communication network of a wireless communication business entity, and although a detail is not especially shown, it has a function of separation/mixing, and in routes of transmission and reception, functions of transmission (reception) processing (down convert, noise rejection and amplification etc.), modulation (demodulation), encoding/decoding, A/D conversion etc.

A configuration for realizing these communication functions is utilized in case of sending data from the portable terminal 1 to a broadcasting station, at the time of an interactive data transmission service of digital broadcasting.

In this embodiment, the portable terminal 1 has, as a notifying section, a LED light emitting section 22 which has operation keys emitted light, in addition to a vibrator (not shown in the figure) for informing an incoming call.

The LED light emitting section 22 is disposed also for key illumination during nighttime hours etc., but here, it is further used for informing whether an interactive service of data broadcasting is available or not by use of light emission control of LED. Detail of the control will be described later.

In this example, the control section 11 includes a broadcasting wave monitoring section 23 which monitors (judges) whether broadcasting waves correspond to an interactive service, and a key operation/light emission control section 24 which controls enable/disable of a key operation and light emission of LED.

It is all right even if these broadcasting wave monitoring section 23 and key operation/light emission control section 24 are disposed as hardware in an inside of the control section 11. In this regard, however, in case that the control section 11 is configured by CPU etc., it is desirable to realize the broadcasting wave monitoring section 23 and the key operation/light emission control section 24 as software, as a function on its built-in program.

The broadcasting wave monitoring section 23 monitors, for example signals in the multiple separation section 15, and detects (judges) whether or not data streams of digital broadcasting includes the above-described data which corresponds to an interactive service. Alternatively, it monitors (judges) whether an interactive service is watched/listened by an operation of a user.

The key operation/light emission control section 24 carries out key operation control of enabling all or a part of all operation keys which can be selected in a response (data transmission) of an interactive service of data broadcasting, when the interactive service is possible, and of disabling them when it is not possible. This enable/disable of operation keys can be controlled so as to be “enable” during such a period that data of an interactive service is detected by the broadcasting wave monitoring section 23 etc., and to be “disable” when it becomes undetected. In addition to this, it is possible to set “enable” in case that data transmission of an interactive service is possible, and “disable” in case that it is impossible.

The key operation/light emission control section 24 controls the LED light emitting section 22 in such a manner that an enabled operation key emits light (turns on alight), and a disabled operation key stops light emission (turns off a light) or blinks on and off.

Meanwhile, in case that there is a telephone incoming call during a period of data broadcasting and an off-hook button is pushed and it enters into a talking mode, in a receiving mode of normal digital broadcasting which is not data broadcasting and an operation mode (e.g., radio reception etc.) other than data broadcasting, key operation control and light emission control at the time of the above-mentioned data broadcasting are released. Alternatively, if it is not possible to carry out a transmission operation which corresponds to an interactive service because it is during a period of communication, the LED light emitting section 22 is controlled in such a manner that an operation key stops light emission (turns off a light) or blinks on and off.

Meanwhile, in case that there is need to temporarily store information at the time of the above-mentioned image processing, data processing and sound processing, the memory section 21 can be utilized also as its temporary storage memory. In addition, in case that memory capacity is large, it is possible to store these information. It is all right even if an external memory, which is attached from an outside in an attachable and detachable manner, is disposed for storing information.

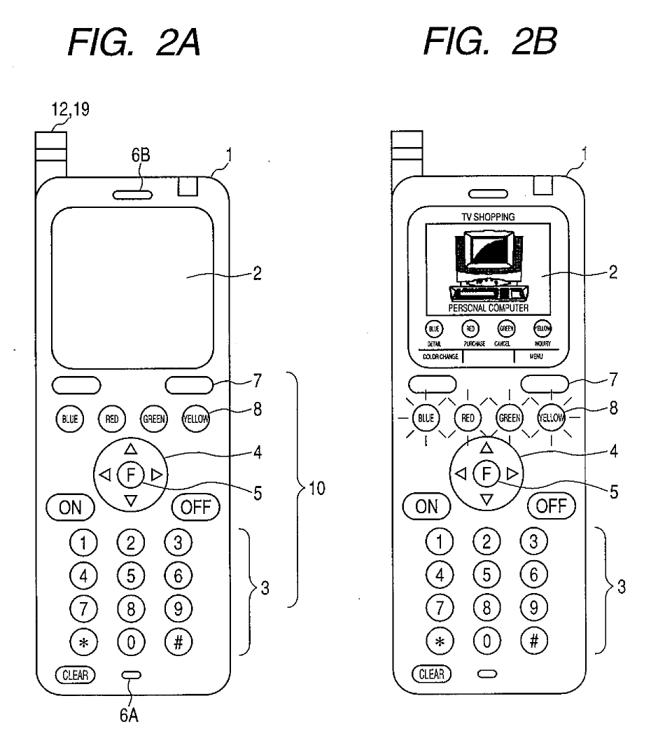

FIG. 2 (A) is an external appearance view which shows such a situation that it is possible to view operation keys and a display section of the portable terminal 1. Meanwhile, this external appearance view shows a straight type portable terminal 1, but in case of a flip type, a slide type or a turn type, it becomes possible to view necessary each section even in such a situation that a portable terminal is opened, or even in such a situation that it is made operable by sliding, and in that way, it is the same, so that there is no need to limit to this embodiment.

In a situation shown in FIG. 2 (A), the display section 2 for displaying image information, data broadcasting etc., a sound input section 6A and a sound output section 6B, the key operation section 10 etc. appear.

As each section of the key operation section 10 which appears in FIG. 2 (A), number keys 3 for inputting numbers and characters, a direction key 4 which carries out cursor movement and movement of menu items, a decision key 5 for deciding a selected item, a soft key 7 to which various functions are allocated depending on contents displayed on a screen, and so on are placed on a lower side of the display section 2.

In the key operation section 10 in this embodiment, color buttons 8 of four colors, which correspond to an interactive service of terrestrial digital broadcasting, are further placed. It is desirable that these color buttons 8 are ones of the same colors, same arrangement as color buttons which are mounted on a remote controller of a stationary type terrestrial digital TV.

In an inside of the portable terminal 1 which corresponds to a back side of the color buttons 8 of four colors, the LED light emitting section 22, which is shown in FIG. 1, is disposed. The LED light emitting section 22 is a thing which arbitrarily lights up the color buttons 8 of four colors through a colored window, or by LED luminescent colors, and their colors are set up to “blue”, “red”, “green”, and “yellow”.

FIG. 2 (B) shows such an appearance that an electromagnetic reception status of a communication line is notified to a user by light emission of LED which corresponds to a color button at the time of receiving data broadcasting. Hereinafter, “data broadcasting” means digital broadcasting which corresponds to an interactive service.

In an example shown in the figure, data broadcasting is TV shopping, and it shows such a situation that a screen at the time of deciding purchase of a commercial product (here, a personal computer) is displayed on the display section 2. This screen shows an external appearance of a personal computer and button operation display. By this means, it is understood that the “blue” button is pushed in case of skipping to a detailed commercial product explanation screen, and the “red” button is pushed in case of purchase, and the “green” button is pushed in case of cancel, and the “yellow” button is pushed in case of inquiry.

In addition, in the example shown in the figure, all of the color buttons 8 of four colors of the portable terminal 1 are lighted up. This shows such a situation that an electromagnetic wave reception status etc. are good, and it is possible to carry out transmission from the portable terminal 1, and it is possible to do about an interactive service.

In addition, in this example, it is configured so as to have the color buttons 8 emitted light by LED, but it is possible to have the direction key 4, the decision key 5 and/or number keys 3 emitted light as an operation key by which it is possible to input. For example, in case of selecting a commercial product category prior to this commercial product purchase screen, the direction key 4 and the decision key 5 are lighted up according to need, and after that, the commercial product purchase screen is displayed, and in case that a user pushes the “red” color button 8 and decides purchase, it is possible to turn the number keys 3 into a lighting-up situation on the occasion of inputting a cash card number and a user registration validation number, and to inform that an input from it is possible. In this embodiment, in case that the color buttons 8 of four colors and other keys are lighted up, it shows that it is possible to do about an interactive service, and in case that they blink on and off (or are turned off), it shows that an electromagnetic wave reception status etc. are bad, or because of another reason, it is impossible to do about an interactive service.

Meanwhile, in the above-mentioned example, the color buttons 8 are exemplified, but it is applicable to a method of operating a cursor by the direction key 4 without using the color buttons 8 and carrying out an input by the decision key 5, a method of carrying out an input by use of the soft key 7, and so on.

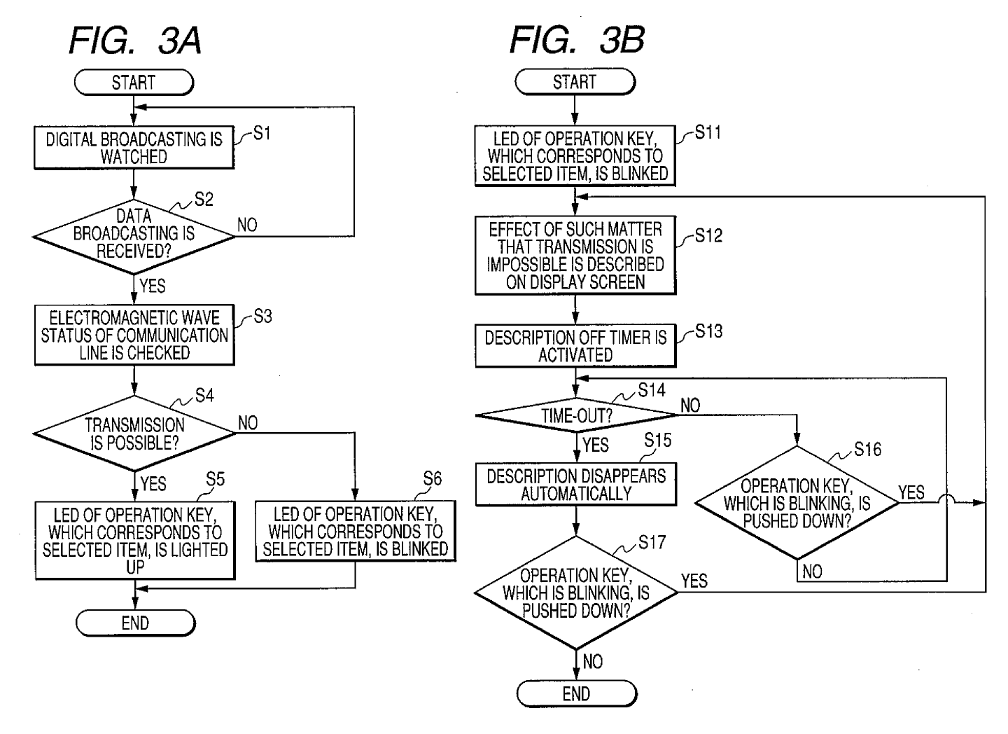

FIG. 3 (A) shows a flow chart of basic light emission control of LED in the portable terminal 1.

The portable terminal 1 in this embodiment is a thing which carries out light emission control by using, as a trigger, such a matter that digital broadcasting (data broadcasting), which corresponds to an interactive service, is received.

Hereinafter, steps S1 through S6, which are shown in FIG. 3 (A), will be explained over arbitrarily referring to FIGS. 1 and 2.

Digital broadcasting is received, and a channel is selected, and watching of a specific program is started, and then, it is turned into a watching situation (S1). The watching situation of this step S1 includes to watch another program by user's changing a channel.

In mid-flow as this watching situation continuing, reception of data broadcasting is monitored periodically by the broadcasting wave monitoring section 23 shown in FIG. 1 (S2). Here, “reception of data broadcasting” means any one of the following cases.

1. Case that an initial program as the time of TV start-up is data broadcasting,

2. Case that a user pushes down a specific key and changes over to data broadcasting,

3. Case that a user purposefully changes over a channel to a program including data broadcasting, and

4. Case that data of data broadcasting is overlapped with a program which is now watched, at specific timing.

When “reception of data broadcasting” is detected in any one of the above-mentioned cases, the control section 11 shown in FIG. 1 judges that digital broadcasting, which is currently received, is data broadcasting, and checks a reception status of electromagnetic waves from the wireless section 20 (S3). For example, in case that the wireless section 20 has a received field strength indication (RSSI: Received Signal Strength Indicator) circuit, the control section 11 receives, as an input, a received field strength signal from that circuit, and checks (judges a line status) a current electromagnetic wave status (reception status) from this signal.

On the one hand, when reception of data broadcasting is not detected in the step S2, the control section 11 shown in FIG. 1 returns processing to the step S1 and checks that it is a situation of watching digital broadcasting, and thereafter, detection of reception of data broadcasting is tried again in the step S2, after the passage of a given length of time. Then, this operation is repeated periodically within watching time of digital broadcasting. Meanwhile, when watching termination of digital broadcasting is detected in the step S1, the processing flow is terminated compulsorily.

When an electromagnetic wave reception status of a communication line is checked in the above-mentioned step S3, the control section 11 judges whether data transmission from the portable terminal 1 is possible or not, for the purpose of an interactive service of data broadcasting, on the basis of its check result (S4).

In case that data transmission is possible, the control section 11 shown in FIG. 1 controls the key operation/light emission control section 24, and carries out user notification depending on a result of that electromagnetic wave reception status (S5 and S6).

In more detail, in case that a reception status is good and data transmission is possible for an interactive service of data broadcasting, LED of a predetermined button and operation key in the key operation section 10 shown in FIG. 2 is turned on (S5). On the one hand, in case that a reception status is bad and it is impossible to do about an interactive service of data broadcasting, LED of a predetermined button and operation key is blinked on and off (S6).

This lighting-up and blinking may be terminated in case that there is a user operation, or may be terminated in case that data transmission for an interactive service is completed, or terminated when a given length of time passes even if there is not a user operation. A preferable example of this termination processing will be explained in subsequent FIG. 3 (B). When lighting-up or blinking of LED is terminated, the processing is completed.

According to light emission control of LED shown in FIG. 3 (A), when the portable terminal 1 is in a reception area of a communication line and a received field strength is strong, it is possible to light up a color button etc. to which it is possible to input data, by LED, as a data input key of data broadcasting. In addition, at the time that communication is unstable because of an outside of a reception area, a trouble and so on and it is difficult to carry out transmission from the portable terminal, it is possible to blinks the above-mentioned color button etc. In this case, at the time that the color button etc. are blinked on and off, it is impossible to carry out transmission from the portable terminal 1, regardless such a fact that the portable terminal 1 is receiving broadcasting waves of data broadcasting, and therefore, it is possible to easily notify a user that it is not possible to do about an interactive service of data broadcasting.

In this LED light emission control method, it is desirable to add a step of checking a watching situation of digital broadcasting again (the same step as S1), after the steps S5 and S6. When a watching situation of digital broadcasting is confirmed in this step, processing is returned to the step 2, and in case that it is not confirmed, it is terminated.

If it is carried out in this way, it is possible to monitor data broadcasting continuation confirmation on a steady basis, and it is possible to monitor an electromagnetic wave reception status, on a steady basis, in response to such a matter that the electromagnetic status fluctuates in the portable terminal 1 which is premised on movement. As a result, it is easily detected that a reception status of data broadcasting is changed in the above-mentioned four cases, and it becomes possible to carry out LED light emission control depending on it. In addition, when it is moved from an inside of a data communication available range to an outside of the range, LED light emission is changed from lighting-up to blinking, and inversely, at the time of movement from an outside of the range to an inside of the range, it is possible to change LED light emission from blinking to lighting-up.

Although it is expected that a basic operation system of data input keys for data broadcasting is different, when it is configured so as to light up an operation key by which it is possible input, and to blink the operation key in case that it is impossible to input, in the LED light emission control method shown in FIG. 3 (A), it is easily understandable visually to a user, as to a range of an operation key, i.e., from which range, a button etc. are selected to carry out an input, even if an operation system of data input keys is different in what manner, and there is consistency.

In addition, it is conceivable that the number of items, which can be selected in an interactive service, fluctuates in a range of 1 through 4 items by data which is sent from a broadcasting station, but even in that case, for example in case of 4 items, 4 keys emit light, and in case of 2 items, 2 keys emit light, and in this way, only an operation key by which an input is possible, is lighted up, blinked, and therefore, it eliminates such a case that a user is puzzled by an operation method.

Furthermore, assuming that it is possible to identify the color buttons 8 of four colors shown in FIG. 2 only by color information, it wants for consideration to a handicapped person having defect in color perception, only by that. However, in this embodiment, an operation key by which an input is possible is restricted by lighting-up and blinking of LED, and therefore, it is easily operated even by a handicapped person having defect in color perception. As to such a matter that a handicapped person having defect in color perception should operate which button among the color buttons 8 of four colors, it is understandable if characters for displaying colors of “blue”, “red”, “green” and “yellow” are described on, for example, the color buttons 8 of four colors. This arrangement order becomes much better if uniformity with screen display of data broadcasting is given thereto.

Meanwhile, the above-mentioned “blinking” is one embodiment, and there is no need to limit to the above-mentioned embodiment, if it is a thing such as turning off a light and emitting light by a specific color, which a user can understand that it is not possible to carry out data transmission.

In addition, by configuring in such a manner that the control section etc. controls so as to give warning by a vibrator and warning sound, on the occasion that a user pushes a key (button) which shows that data transmission is impossible, it is possible to surely report an operating status to a user.

By the foregoing, it is possible to provide the portable terminal 1 which has no worry of imposing a burden of an operation on a user and gives consideration also to a handicapped person having defect in color perception.

FIG. 3 (B) shows a flow chart regarding description of a display screen after blinking of LED. Hereinafter, steps S11 through S17 shown in FIG. 3 (B) will be explained over arbitrarily referring to FIGS. 1 and 2.

When predetermined LED blinks (S11) in the same manner as in the step S6 of FIG. 3 (A), display with effect of “(an electromagnetic wave status is bad and) transmission is impossible” is carried out on the display section 2 shown in FIGS. 1 and 2 (S12), and at nearly the same time as this, a description OFF timer is activated (S13). In the case of FIG. 1, as to this description OFF timer, it is all right if clock means which CPU as the control section 11 possesses normally, e.g., RTC (Real-Time Clock) is utilized, and it is also all right even if it is disposed separately form this. Activation control of this timer is carried out by the control section 11.

After that, the control section 11 detects whether or not predetermined time of the OFF timer expires (time-out) (S14), and in case of time-out, the description, which is displayed on a screen in the above-mentioned step S12, is turned off automatically (S15). On the one hand, in case that time-out is not detected in the step S14, it is turned into a standby state until time-out.

During this standby period, or after automatic disappearance of description, it is checked that a blinking operation key was operated (e.g., pushed down) by a user (S16 and S17). In this case, the control section 11 returns a processing flow to a previous one of the step S12. By this means, during a period of description, the description OFF timer is reset, and a description period is extended, and after automatic disappearance of description, description display of a predetermined period is started again.

According to processing shown in FIG. 3 (B), description having an effect of “transmission is difficult” is carried out on the display section 2 after blinking of the color buttons 8 of four colors, at the time that transmission from the portable terminal 1 is difficult, and it is possible to surely notify this matter to a user.

In addition, in the processing shown in FIG. 3 (B), since there is such a possibility that this description having an effect of “transmission is difficult” becomes an obstacle of TV watching, it disappears automatically after the passage of a fixed length of time, by the description OFF timer.

Furthermore, on the occasion that a user pushes down an operation key where LED blinks, after the above-mentioned description disappearance, this effect is described again, and it is notified to a user once more that the current portable terminal 1 is in such a status that transmission is difficult and does not support an interactive service of data broadcasting. On this account, in case that an inexperienced user pushes down an operation key without knowing a meaning of blinking of LED, it becomes easy for the user to learn the meaning of LED blinking.

By the foregoing, an operation method of the portable terminal 1 is simplified widely, in an easily visually understandable fashion, and it becomes possible to remarkably improve operability of a user.

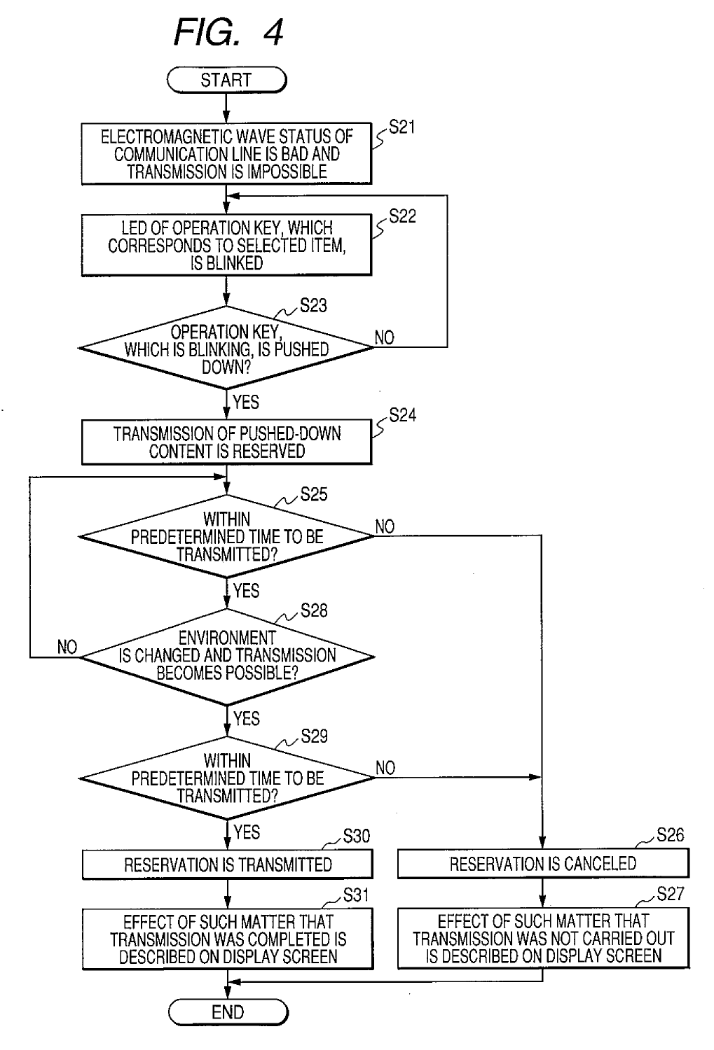

FIG. 4 shows a flow chart of another embodiment regarding description of screen display.

Hereinafter, steps S21 through S31 shown in FIG. 4 will be explained over arbitrarily referring to FIG. 1.

In case that it was judged as “(an electromagnetic wave status of a communication is bad, and) transmission is impossible” in the step S4 of FIG. 3 (A) (S21), the control section 11 shown in FIG. 1 (key operation/light emission control section 24) controls the LED light emitting section 22, and blinks LED of a predetermined operation key, in the same manner as the step S6 of FIG. 3 (A) and the step S11 of FIG. 3 (B) (S22). Then, it is investigated by the control section 11 whether an operation key, which is blinking, is pushed down or not (S23). At this time, if a key operation is not detected, the steps S22 and S23 are repeated, and it is turned into a key operation standby status.

When a key operation is detected in the step S23, transmission data (pushed down content), which corresponds to an interactive service of data broadcasting, inputted from the key operation section 10 of FIG. 1 by the key operation, is reserved (S24), and stored temporarily in a memory section (e.g., memory section 21 of FIG. 1). This reservation processing is also carried out by the control section 11.

Next, it is investigated whether it is within predetermined time to be transmitted (S25). In case that it is within predetermined time, processing is advanced to a route in which transmission of reservation content is possible (S28 through S31), and in case that it exceeds predetermined time, processing is diverged to a reservation cancel route (S26, S27).

With regard to the step S25, it is desirable that the broadcasting wave monitoring section 23 shown in FIG. 1 extracts information of predetermined time to be transmitted, from a data stream of digital broadcasting, and the control section 11 compares this extracted time information (including start time of a program) with current time, and on the basis of a comparison result, passage of the above-mentioned predetermined time is judged. In this regard, however, it is also possible for a user to arbitrarily set up predetermined time to be transmitted, on the side of the portable terminal 1. Even in that case, in order to avoid generation of a situation which is against a user's intention by the passage of time, and also, in order to avoid data transmission to a different program, it is desirable to extract information of predetermined time from a data stream of data broadcasting, as described above, and to use this extracted time information, in preference to time information which is set up by a user.

When the passage of predetermined time is detected in the step S25, the control section 11 shown in FIG. 1 cancels reservation contents (S26), and thereafter, control the display section 2 to display description having an effect of “transmission could not be carried out” on its display screen (S27), and terminates processing.

On the one hand, in case that predetermined time has not yet passed in the step S25, it is checked by the control section 11 whether an environment (electromagnetic wave status) changed and transmission became possible (S28), and in case that transmission is still impossible, processing is returned to the step S25. By this means, a loop of the steps S25 and S28 turns over within predetermined time, and when passage of the predetermined time is detected during that period, it is shifted to the reservation cancel step S26.

When it is judged in step S28 that transmission is possible, passage of the predetermined time is checked again (S29), and when the passage of the predetermined time is detected at this step, the process is shifted to the reservation cancel step S26.

Subject to such a matter that it is shifted to a status that transmission is possible and it is within predetermined time, the control section 11 shown in FIG. 1 issues an instruction for transmitting a reservation content (S30). As a result, reservation content (transmission data), which was readout from a memory section, is transmitted to an outside by the wireless section 20 and the communication antenna section 19. After that, the control section 11 controls the display section 2, and thereby, description with an effect of “transmission was completed” is displayed on its display screen (S31), and processing is terminated.

According to control shown in FIG. 4, in case (of “Yes” in S23) that a user inputs a transmission content by pushing down an operation key which corresponds to a selected item, in such a LED blinking status that transmission is difficult, that transmission content is reserved (S24). At this time, it is all right even if an effect of “transmission was reserved” is described on a display screen.

After that, subject to the passage of predetermined time to be transmitted (“Yes” in both of S25 and S29) and shifting to a transmission possible status (“Yes” in S28). A reservation content is transmitted (S30), and description having an effect of “transmission was completed” is displayed on a display screen (S31). Meanwhile, in case that a series of operations from reservation up to transmission are temporally short, it is all right even if description having an effect of “transmission was completed” is not displayed, if unnecessary.

By this series of processing, a user can know that transmission was surely carried out. In addition, since transmission is carried out in wait for such a matter that a transmission content is reserved and transmission conditions are in order, there is no need for a user to carry out an overlapped operation. In sum, in case that a transmission content is not reserved (stored), when an electromagnetic wave status is turned for the better and the transmission conditions are in order, a user has to input a transmission content by pushing down an operation key which is blinking, again, but, in the control shown in FIG. 4, there is such an advantage that it does not require it and easy to use.

In the control shown in FIG. 4, in case that a result of the check of passage of predetermined time in the step S25 is “No”, reservation is canceled immediately (S26), and description with an effect “reservation was canceled” is displayed on a display screen.

A reason that subsequent processing is differentiated depending on judgment of the step 25 in this way is that it deals with such a matter that, from a constructional viewpoint of a program, there are a program in which transmission timing is restricted to relatively short time like a quiz form, and a program in which reception of relatively long transmission data is possible if it is during a period of program broadcast line TV shopping, and there are short and long in predetermined time to be transmitted (reception time of transmission data of an interactive service). Concretely speaking, when decided predetermined time is short and it has already exceeded the predetermined time, it counts for nothing even if transmission processing is advanced, and in addition, time of storing a reservation content in a memory section for nothing is generated, and timing of opening up its memory capacity in such a manner that it is possible to be used for others becomes late, and as a result, increases of a burden to CPU and a memory and unavailing electric power consumption are generated.

The control shown in FIG. 4 can cancel a reservation content which is wasted even if it is transmitted since predetermined time to be transmitted has already passed, as quickly as possible, and therefore, there is such an advantage that it is possible to suppress increase of a burden to CPU and a memory and increase of unavailing electric power consumption.

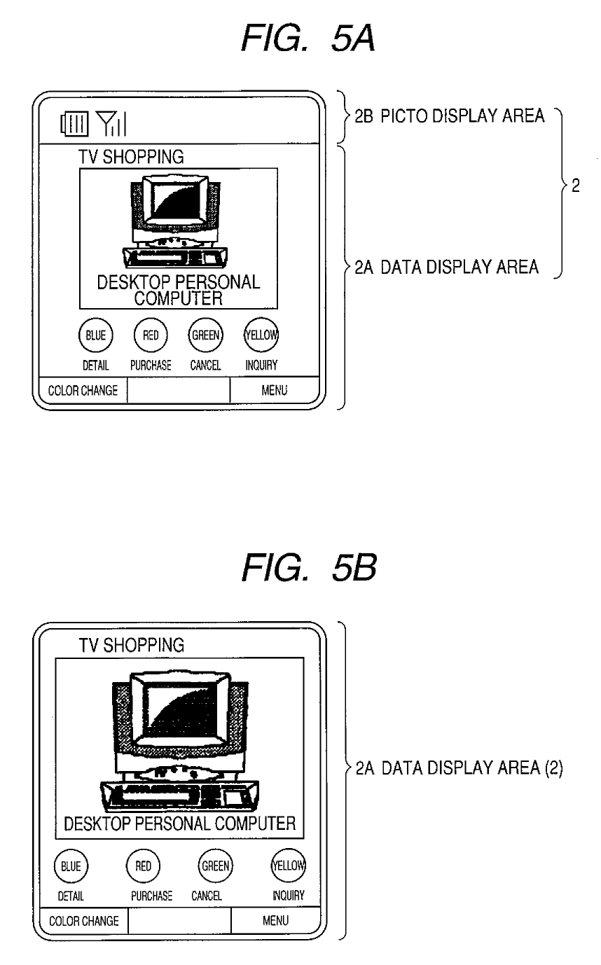

FIGS. 5 (A) and 5 (B) show one example of a program screen utilizing an interactive service of terrestrial digital broadcasting in a portable terminal.

A screen of the display section 2 shown in FIG. 5 (A) is sectioned into a display area of broadcasting images etc. (data display area) 2A, and a display area of pictograph (pictorial symbols) which shows a remaining battery level, an electromagnetic wave strength and so on (hereinafter, referred to as picto display area) 2B. This is such a thing that an effective display area of one display device is divided into the data display area 2A and the picto display area 2B, and both sides are displayed. On that account, in case that display of pictograph is necessary, a part of the data display area is allocated for the picto display area 2B, and therefore, the data display area 2A after the allocation becomes small.

FIG. 5 (B) shows such an appearance that the picto display area is turned into non-display and the data display area is displayed on a full screen of a display screen of a portable terminal.

On the occasion of watching television broadcasting by use of a small display screen like that of a portable telephone, a user's wish is that the user wishes to watch by use of a larger display screen as much as possible.

Then, in this embodiment, during a period of watching normal digital broadcasting, in a period except processing time for transmission at the time of watching data broadcasting, it is desirable to stop display of the picto display area 2B and use a full screen of an effective display screen of the display section 2, as the data display area 2A, as shown in FIG. 5(B). Here, for example, a period after judgment of the step S2 in FIG. 3 (A) became “Yes” and up to the time that processing is terminated, falls under the “processing time for transmission at the time of watching data broadcasting”. In this case, display of pictograph is carried out from begging to end, from start to end of processing in FIGS. 3 (B) and 4. It is all right even if non-display of pictograph is arbitrarily carried out during this period, but in case that the picto display area 2B includes pictograph for use in checking an electromagnetic wave status, it is desirable within the meaning that a user can actually check good or bad of an electromagnetic wave status.

It is all right if the display of this picto display area 2B is started on the basis of such a matter that the broadcasting wave monitoring section 23 shown in FIG. 1 detected that it is data broadcasting, and terminated on the basis of termination of data communication which corresponds to an interactive service of data broadcasting, determination of transmission impossible, or termination of data broadcasting etc. Meanwhile, in case of normal digital broadcasting, and in case that there was a telephone incoming call without limiting to data broadcasting, the picto display area 2B is automatically displayed at any time.

In the meantime, it is common that the picto display area 2B is used by turning it into non-display when an image is watched, and in the suchlike case, in order to do about an interactive service, an operation of displaying the picto display area 2B, which was turned into non-display, again, for the purpose of checking an electromagnetic wave reception status of a communication line.

In contrast to this, in this embodiment, changeover of display/non-display of the picto display area 2B is automatically carried out in a cooperative fashion, and it is possible to save user's labor for an operation.

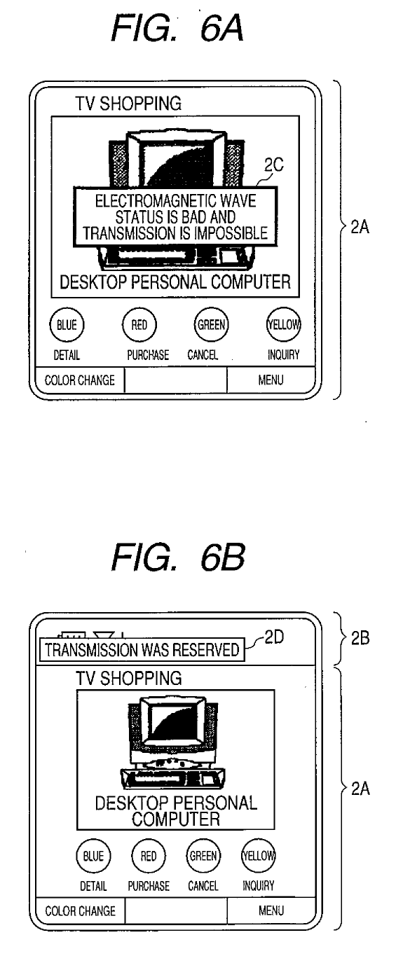

FIGS. 6 (A) and 6(B) show an example of a message (description) regarding processing and a status. It is all right if description at such timing that a next operation is not conceivable to be carried out, for example like “an electromagnetic wave status is bad and transmission is not possible” (2C) etc. shown in FIG. 6 (A), is displayed so as to be overlapped with the data display area 2A in order to achieve prominence, and is automatically terminated by OFF timer processing.

On the one hand, it is all right if description at such timing that it is assumed there is an operation by a user continuously, such as reservation change etc. after a broadcasting screen is watched, for example like “transmission was reserved” (2D) etc. shown in FIG. 6 (B), is displayed so as to be overlapped with, for example, the picto display area 2B, in order to be out of the way of screen display, or displayed by use of icon etc. showing that effect. This description is automatically terminated by using a next operation as a trigger, or by OFF timer processing. In the example of FIG. 6 (B), it is possible for a user to carry out a change of a reservation content over looking at a screen.

Hereinafter, major advantages (benefits) in this embodiment, will be explained by comparison with a comparative example.

### COMPARATIVE EXAMPLE

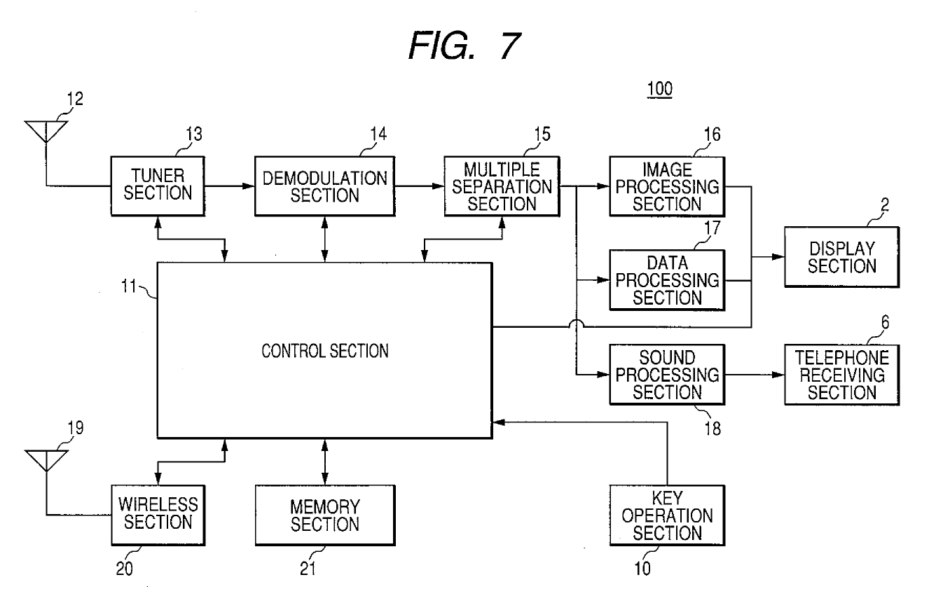

FIG. 7 is a block diagram of a portable terminal which relates to the comparative example.

This portable terminal 100 is different from the portable terminal 1 (FIG. 1) in this embodiment, on such points that it does not have the key operation/light emission control section 24 and a function of the key operation/light emission control section 24 in the control section 11, and the LED light emitting section 22 is not disposed.

The portable terminal 100 of this comparative example, although it is not shown in the figure especially, has a direction key used for a menu operation and cursor movement by which it is possible to select up, down, left and right, 4 directions, and a decision key used for a menu selection etc., and carries out various calling out and terminal operations, by use of these things. In addition, in an improved user interface, two or three keys are placed immediately beneath a display screen, in addition to the above-mentioned keys, and a function of “return” etc. are allocated with respect to each display screen, and thereby, it has become to process a lot of functions easily. In addition to this, there is such a case that a key called as a side key is placed on both sides of a terminal, and functions are allocated to these things.

In case that the suchlike portable terminal 100 received digital broadcasting received waves fraught with an interactive service, there is need to notify an operation key which can be selected according to an interactive service, to a user.

In order to respond to this need, it is also possible to adopt such a method that a plurality of operation keys, which can be selected for an interactive service, are disposed, and they are displayed with different colors, and a key to be selected is specified by using a color as a clue. However, there is such a drawback that it wants for consideration to a handicapped person having defect in color perception.

In the meantime, the portable terminal 100 already has a lot of operation keys along with realization of high performance thereof. On this account, worrying about such a matter that an operation method becomes complex by more increase of operation keys, it is conceivable to respond by allocating a selection function of an interactive service to an existing operation key, without newly adding an operation key. For example, it is conceivable to display “in case of . . . , please push “0”, and in case of . . . , please push “1”” etc. on a broadcasting screen. However, it is inconvenient to a user, since there is such a case that the user pushes another key by erroneously reading a checking text.

In addition, especially in the portable terminal 100 which is premised on movement, there is such a case that a trouble is generated in a communication line and a terminal itself, and furthermore, such a case that data transmission is impossible in some locations, because of an interactive service. For example, since receiving areas of digital broadcasting waves and data communication waves are different, even if a user has such an intention that the user wishes to join during a period of watching a program fraught with an interactive service in broadcasting waves, it is outside the area where it is possible to receive communication waves. Alternatively, there is such a case that electromagnetic wave strength is unstable by the reason that a trouble is generated. On this account, a situation that it is not possible to carry out transmission from a portable terminal is likely to occur. In the suchlike case, it is inconvenient if there is need to carry out data transmission after a user checked reception sensitivity. In addition, it is inconvenient if it is not possible to check whether data transmission is possible, and carried out effectively or not.

In contrast to this comparative example, the portable terminal 1 in this embodiment has the following benefits.

It is possible to visually recognize an operation key, which can be selected and is effective in data broadcasting fraught with an interactive service, by a status of key's emitting light (lighting up). Especially, since an operation key by which an input is possible is lighted up, a user who is of low use of data broadcasting, and a user who utilizes it for the first time, can identify it at one glance. In addition, since an operation key by which an input is possible is lighted up, a handicapped person having defect in color perception can specify it. By this easiness of visual recognition of a selected key, it is possible to guide a user to a next operation smoothly, and it does not have to worry, and it is easy to use.

In addition, it is possible to visually recognize that it is not possible to utilize an interactive service, by a status of an operation key's emitting light (blacking out or blinking), and this remarkably increase operability of a portable terminal in an interactive service. Therefore, there is no need for a user to carry out an unavailing operation such as input and transmission of information. This is a benefit, also judging from an aspect of a processing burden and unavailing consumption of electric power.

By mounting the color buttons 8 on the portable terminal 1, it is possible to adopt a consistent operation method which is the same as that for a remote controller of a stationary type terrestrial digital TV. On this account, it eliminates such a case that a user is puzzled by an operation method, and pervasion, popularization of a service are facilitated.

When an operation is carried out by a user in such a status that it is not possible to utilize an interactive service, a status of the operation (operated key and its procedure) is stored, and reservation of data transmission is carried out. Then, when it is turned into such a status that an interactive service is available, stored information is automatically read out and transmitted. On this account, it avoids double labor hours for a transmission data input by a user, and it eliminates a burden of monitoring that an interactive service becomes available, and it is easy to use.

On the one hand, in case of continuing such a status that data transmission is impossible even if predetermined time has passed, reservation is automatically canceled, and a memory are, in which information was stored, is released, and therefore, memory utilization efficiency is high. If this predetermined time is obtained from data of an interactive service, it can be interlocked with response possible time of a program, and certainty of judgment of right and wrong of data transmission is high.

In a part of all of 4 statuses of a status that an electromagnetic wave status is bad and data transmission is not possible, a status that reservation was carried out, a status that transmission of a reservation content was completed, and a status that reservation was canceled, it is possible to display descriptions (messages etc.) of explaining that statuses. By this means, feeling of security is given to a user about progress of processing, and a user is released from a monitoring burden of the progress, and in addition, this gives a user recognition about what-like state transition was brought about by a result of an operation by oneself, and generates a learning effect.

The above-described embodiment is simply exemplification of the present invention, and it does not mean that the present invention is limited to the above-described embodiment.

What is claimed is:

1. A digital broadcasting receiving apparatus comprising:
a judgment section which judges whether or not digital broadcasting corresponding to an interactive service is received; and
a control section which enables an operation section corresponding to the interactive service when it is judged by the judgment section that the digital broadcasting is received and transmission of data corresponding to the interactive service is possible, and which disables the operation section when it is judged by the judgment section that the digital broadcasting is received and the transmission of data corresponding to the interactive service is impossible.

2. The digital broadcasting receiving apparatus as set forth in claim 1, further comprising:
a light emitting section which illuminates the operation section,
wherein the control section notifies the enable/disable of the operation section by light emission control of the light emitting section.

3. The digital broadcasting receiving apparatus as set forth in claim 1, further comprising:
a wireless communication section for use in data communication, which can carry out the data transmission for the interactive service; and
a status judgment section which judges an electromagnetic wave status used by the wireless communication section,
wherein the control section judges whether or not the transmission of data corresponding to the interactive service is possible based on the electromagnetic wave status judged by the status judgment section.

4. The digital broadcasting receiving apparatus as set forth in claim 1,
wherein the control section controls, when the operation section is operated in a state that the operation section is disabled, holding of information based on the operation and reserving of data transmission and transmitting of the held reserved information when the data transmission becomes possible.

5. The digital broadcasting receiving apparatus as set forth in claim 4,
wherein the control section cancels the transmission reservation and deletes the corresponding information when the reserved data transmission is not carried out within a predetermined period of time.

6. The digital broadcasting receiving apparatus as set forth in claim 5,
wherein the control section obtains the predetermined period of time from data of the interactive service.

7. An operation control method comprising steps of:
monitoring whether or not digital broadcasting corresponding to an interactive service is received; and
enabling an operation section corresponding to the interactive service when the digital broadcasting is received and transmission of data corresponding to the interactive service is possible, and disabling the operation section when the digital broadcasting is received and the transmission of data corresponding to the interactive service is impossible.

8. The operation control method as set forth in claim 7, further comprising a step of:
judging whether or not the transmission of data corresponding to the interactive service is possible based on a status of wireless communication of a wireless communication business entity to a communication network.

9. The operation control method as set forth in claim 7, further comprising a step of:
notifying enable/disable of the operation section by light emission control of the operation section.
